(19) United States
(12) Patent Application Publication
(10) Pub. No.: US 2005/0039636 A1
(43) Pub. Date: Feb. 24, 2005

(54) Heat shielding surface layer

(76) Inventor: Yasumasa Matsumoto, Nishinomiya-shi (JP)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/499,604

(22) PCT Filed: Dec. 12, 2002
(86) PCT No.: PCT/EP02/14133

(30) Foreign Application Priority Data
Dec. 20, 2001 (EP) 018112508

(51) Int. Cl. C09B 67/52; C09D 201/00

(52) U.S. Cl. 106/494; 106/495; 106/500

(57) ABSTRACT

A solar heat-reflecting plastic composition excellent in weather resistance which comprises, as main ingredients thereof, at least one resin and at least two organic pigments selected from the group consisting of (a) condensed azo type yellow pigment, (b) isoindolinone type yellow pigment, (c) isoindolinone type orange pigment, (d) diketopyrrolopyrrole type orange pigment, (e) diketopyrrolopyrrole type red pigment, (f) condensed azo type red pigment, (g) anthraquinone type red pigment, (h) quinacridone type red pigment,(i) quinacridone type violet pigment, j) anthraquinone type blue pigment, (k) phthalocyanine type blue pigment and (l) phthalocyanine type green pigment, wherein said organic pigments are incorporated into the composition in an amount of 0.01 to 2% by weight based on the total plastic composition according to the addition-mixing method so as to form a black, brown, gray, violet, blue or green color.

The invention relates to a colored solar heat-reflecting plastic composition excellent in weather resistance.

When vehicle, furniture and the like are exposed to direct sunlight, their parts to come into contact with human body are heated and the surface temperature rises, so that the vehicle, furniture and the like become unusable before such parts are cooled. Thus, it has hitherto been intensively desired to solve this problem radically. For instance, the saddles of motor-bicycle and bicycle reach so high a temperature as 80° C. in midsummer, which have to be cooled by some means. In addition, such a rise in temperature much influences the durability of elementary plastic material, causes a deterioration of material quality, and thereby obstructs their long-term use.

In order to cope with such problems, and especially the problem of durability of elementary plastic material, a stabilizer has been added to prevent the thermal deterioration of the material in some cases and an elementary material of high durability has been used in other cases, up to today. On the other hand, regarding the problem of temperature elevation, there has been no means for prevention, so that no method for radical solution of the problem has been found.

U.S. Pat. No. 5,540,998 corresponding to the Japanese Patent Publication Hei 8 (1996)-2593968 describes a solar heat-shielding coating composition which consists mainly of two kinds or more of pigments selected from red, orange, yellow, green, blue and purple pigments in such a manner as to yield a color of low lightness, particularly achromatic black, by additive mixture and a weather-resistant vehicle and a structure covered with said coating composition, with the composition capable of covering the outside of said structure exposed directly to the sun and suppressing a rise in the inside temperature.

Problem to be solved by the invention

The technique so far proposed has aimed at a coating composition for preventing the elevation of temperature inside the structures, and nothing has been proposed regarding the use of a plastic composition or the way for suppressing the elevation of surface temperature. Further, the material used in such a technique has been a colorant for coating compositions, and no consideration has been given to the durability which a colorant for plastics must have, such as heat resistance and migration resistance, so that such colorants have been limited in the usability in a plastic composition. Contrariwise, the present invention makes a proposal about a novel means for preventing the temperature elevation of plastic composition itself, and a composition having a long-term durability at the same time.

Thus, it is an object of present invention to provide a colored plastic composition having a long-term durability with which the elevation of temperature of sheet surface in various vehicles, for example in motorbicycle or bicycle seats, furniture, etc. exposed to direct sunlight can be suppressed in order to insure a comfortable use, and at the same time the thermal deterioration of resin can be prevented.

Means for solving the problems

With the aim of solving the problems mentioned above, the present invention has the following constitution: a solar heat-reflecting plastic composition excellent in weather resistance which comprises, as main ingredients thereof, at least one resin(s) and at least two organic pigments selected from the group consisting of (a) condensed azo type yellow pigment, (b) isoindolinone type yellow pigment, (c) isoindolinone type orange pigment, (d) diketopyrrolopyrrole type orange pigment, (a) diketopyrrolopyrrole type red pigment, (f) condensed azo type red pigment, (g) anthraquinone type red pigment, (h) quinacridone type red pigment, (i) quinacridone type violet pigment, (j) anthraquinone type blue pigment, (k) phthalocyanine type blue pigment and (l) phthalocyanine type green pigment, wherein said organic pigments are incorporated into the composition in an amount of 0.01 to 2% by weight based on the total plastic composition according to the addition-mixing method so as to form a black, brown, gray, violet, blue or green color.

The resin used in the present invention is preferably a resin selected from the group consisting of (A) vinyl chloride resin, (B) polypropylene, (C) polyethylene, (D) ABS resin, (E) methacryl resin, (F) polyethylene terephthalate, (G) polyurethane, (H) polyacetal, (I) fluoroplastic, (J) AES resin, (K) thermoplastic elastomer, (L) unsaturated polyester resin, (M) epoxy resin, (N) phenolic resin and (O) urea resin.

Further, the resin used in the present invention is preferably a resin having excellent weather resistance. The term “resin having excellent weather resistance” used herein means a resin excellent in durability properties such as oxidation resistance, gloss retention, yellowing resistance, etc. and exhibiting stable characteristic properties over a long period of time under irradiation of sunlight Such resins include thermoplastic resins such as vinyl chloride resin, polypropylene, polyethylene, ABS resin, polyethylene terephthalate, polyurethane, polyacetal and fluoroplastics and thermosetting resins such as polyester resin, epoxy resin, phenolic resin and urea resin.

The resin used in the present invention is more preferably a resin selected from the group consisting of (A) vinyl chloride resin, (B) polypropylene, (C) polyethylene and (G) polyurethane. The most preferred resin used in the present invention is a vinyl chloride resin.

Next, the organic pigment used in the composition of the present invention is preferably an organic pigment exhibiting a high weather stability under the condition of long-term sunlight irradiation, a high heat resistance enough to endure the high temperature condition required for the molding and forming of the resins and a high reflectivity in the region of 350-2,100 nm which is prescribed in JIS A5759 as sunlight reflectivity, together with a high migration resistance and a high safety.

It has been found that the characteristic feature of organic pigment mentioned above can be usually exhibited by controlling the chromaticity of molded plastic articles or adjusting the color by an addition-mixing method using yellow, orange, red, violet, blue and green-colored pigments in place of using carbon black conventionally used for black-coloration. That is, it has been found that, when yellow, orange, red, violet, blue and green-colored pigments are used for preparing a color showing roughly the same reflective characteristic property as that of carbon black in the visible light wavelength region not exceeding 750 nm, a color of high reflectivity can be obtained in the near infrared wavelength region exceeding 750 nm.

The term “addition-mixing method” refers to a method of imparting pigments to a resin, said method comprising the steps of
a) mixing at least two organic pigments as defined above into a reaction mixture comprising a resin as defined above using the dry kneading method, the pigment being added in an amount within the range from 0,01 to 2% by weight, the amounts of each pigment being proportioned to produce a desired color,
b) heating the mixture to a temperature at least equal to a melting temperature of the resin to prepare a sheet.

The temperature is in the range of 130-280° C.

The kneading is carried out in a resin kneader as for example in a twin-roll mill or in other known kneading devices.

Prior to mixing the pigment to the resin, each pigment may be mixed with a mixing aid such as a metallic soap to form a dry color mixing having a pigment concentration of 20-80% by weight, preferably of about 50% by weight.

As the yellow-colored pigments of the present invention, condensed azo type and isoindolinone type of ones can be referred to. As the orange-colored pigments, isoindolinone type and diketopyrrolopyrrole type of pigments can be referred to. As the red-colored pigments, diketopyrrolopyrrole type, condensed azo type, anthraquinone type and quinacridone type of pigments can be referred to. As the violet-colored pigments, quinacridone type and dioxazine type of pigments can be referred to. As the blue-colored pigments, anthraquinone type and phthalocyanine type of pigments can be referred to. As the green-colored pigments, phthalocyanine type of pigments can be referred to.

In the present invention, the pigment is used preferably in an amount of 0.01-2% by weight and further preferably in an amount of 0.1 to 2% by weight. When the amount of pigment exceeds the above-mentioned range, flexibility and mechanical strengths of the molded product can be deteriorated. When the amount of pigment is smaller than the range, weather resistance is so bad that coloration and deterioration of resin can take place in the outdoor uses.

Into the plastic composition of the present invention may be incorporated additives such as a metallic soap, an ultraviolet absorber, a lubricant, a filler, a plasticizer and the like, according to the need.

Since the plastic composition of the present invention is excellent in the temperature elevation-preventing effect, the plastic composition can be used quite effectively in cases where motor bicycle, automobile, bicycle, furniture and the like are exposed to direct sunlight outdoors. That is, the composition can be used quite effectively as a sheet for a seat, as a cover sheet for a handle or a saddle, as a cover sheet for sofa, etc. The use thereof, however, is not particularly limited, but the composition of the present invention is usable in any of the well known uses.

### EXAMPLES

Next, the present invention is explained in more detail with reference to the following non-limitative examples. [Formulated Ingredients: Examples 1-5 and Comparative Examples 1-2]
Pigment A: Isoindolinone type yellow pigment Irgazin Yellow 3RLTN of formula 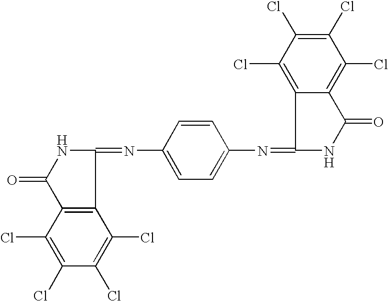
Pigment B: Diketopyrrolopyrrole type red pigment Cromophtal Red 2030 of formula 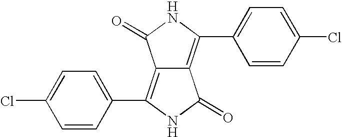
Pigment C: Phthalocyanine type blue pigment Cromophtal Blue 4GNP of formula 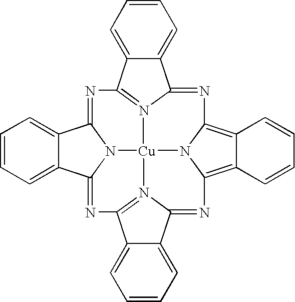
Pigment D: Isoindolinone type yellow pigment Irgazin Yellow 2GLTE of formula 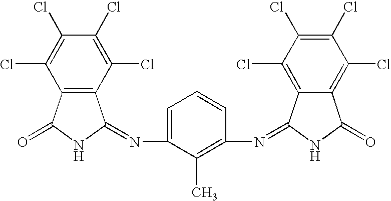
Pigment E: Quinacridone type red pigment Cinquasia Red Y RT-759D of formula 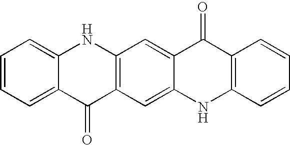
Pigment F: Phthalocyanine type green pigment Irgalite Green GFNP of formula 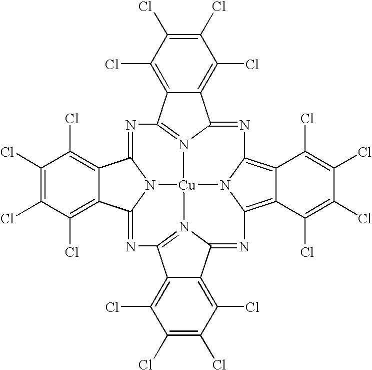
Pigment G: Carbon Black MA-100
Pigment H: Titanium oxide TIPAQUE CR-60

### Method for Preparation of Samples

The pigments were compounded into a plasticized vinyl chloride resin (the weight of vinyl chloride resin was taken as 100% by weight) as compounding ratios shown in Table 1. Each pigment was previously made into a dry color by mixing it with a metallic soap so as to realize a pigment concentration of 50% and homogenizing the mixture for 2 minutes by means of a high-speed mixer, and then the dry color was put to use. The compounded composition was kneaded for 5 minutes by means of a twin roll at 150° C. to prepare a sheet having a thickness of 0.5 mm. The sheet was further pressed by means of a hot press at 155° C. to form it into a pressed sheet having a thickness of 1 mm. The pressed sheets thus obtained were compared with one another.

### Testing Method

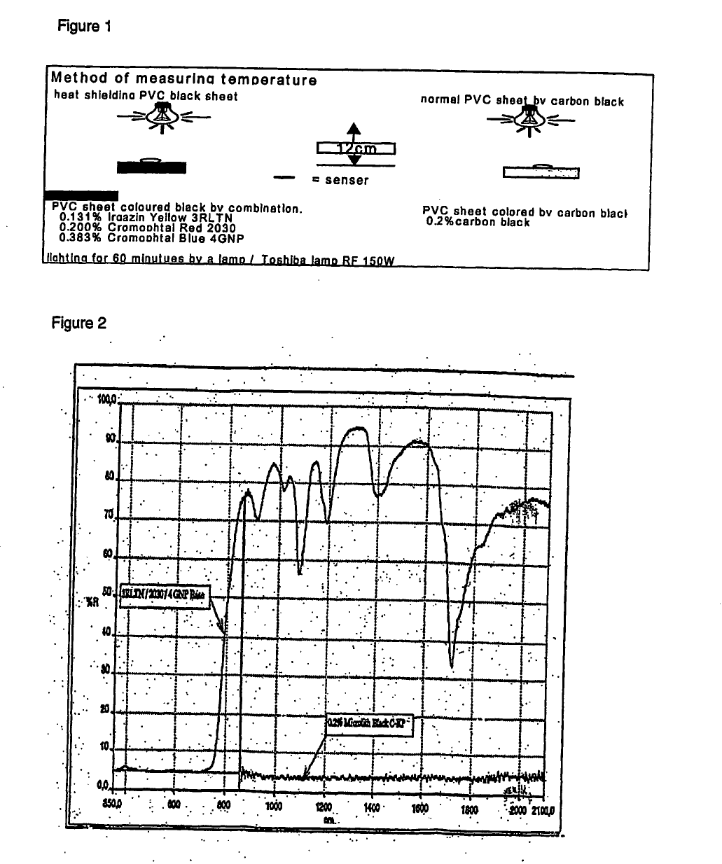

Sunlight reflectivity was measured by the use of a spectrophotometer covering both the visible light wavelength region and the near infrared wavelength region, and an average value of reflectivity was calculated throughout the wavelength region of 350-2,500 nm. Surface temperature was measured by placing a light source (incandescent lamp, Toshiba Lamp RF150W) at a distance of 12 cm over the sample as depicted in FIG. 1, exposing the sample to the light of the lamp for 60 minutes, and then measuring the surface temperature by means of a heat sensor. The results are summarized in Table 1.

FIG. 2 illustrates the reflectivity curves of Example 1 and Comparative Example 1, as typical examples.

TABLE 1
Resin: Plasticized vinyl chloride resin

| | Pigment | | | | | | | | Sunlight | Surface |
|---|---|---|---|---|---|---|---|---|---|---|
| Ex. | A | B | C | D | E | F | G | H | Reflectivity | Temp. |
| 1 | 0.15 | 0.20 | 0.35 | | | | | | 59 | 51 |
| 2 | 0.25 | 0.10 | 0.05 | | | | | 0.15 | 67 | 42 |
| 3 | | 0.10 | 0.20 | 0.20 | | | | 1.00 | 70 | 41 |
| 4 | 0.25 | | 0.20 | | 0.20 | | | | 59 | 50 |
| 5 | 0.20 | 0.20 | | | | 0.30 | | | 59 | 51 |
| C-1 | | | | | | | 0.10 | | 5 | 73 |
| C-2 | 0.30 | 0.05 | | | | | 0.05 | 0.15 | 7 | 63 |

Ex. = Example
C-1 = Comparative Example 1

### Effect of the Invention

The results presented above demonstrate that, by using the plastic composition of the present invention as a surface material of various vehicles and furniture exposed to direct sunlight, the elevation of surface temperature can be prevented and the long-term durability of elementary material constructing them can be improved, to such an extent as to be unexpected from prior methods.

1. A solar heat-reflecting plastic composition excellent in weather resistance which comprises, as main ingredients thereof, at least one resin and at least two organic pigments selected from the group consisting of (a) condensed azo type yellow pigment, (b) isoindolinone type yellow pigment, (c) isoindolinone type orange pigment, (d) diketopyrrolopyrrole type orange pigment, (e) diketopyrrolopyrrole type red pigment, (f) condensed azo type red pigment, (g) anthraquinone type red pigment, (h) quinacridone type red pigment, (i) quinacridone type violet pigment, (j) anthraquinone type blue pigment, (k) phthalocyanine type blue pigment and (l) phthalocyanine type green pigment, wherein said organic pigments are incorporated into the composition in an amount of 0.01 to 2% by weight based on the total plastic composition according to the addition-mixing method so as to form a black, brown, gray, violet, blue or green color.

2. A solar heat-reflecting plastic composition excellent in weather resistance according to claim 1, which comprises, as main ingredients thereof, at least one resin(s) selected from the group consisting of (A) vinyl chloride resin, (B) polypropylene, (C) polyethylene, (D) ABS resin, (E) methacryl resin, (F) polyethylene terephthalate, (G) polyurethane, (H) polyacetal, (I) fluoroplastic, (J) AES resin, (K) thermoplastic elastomer, (L) unsaturated polyester resin, (M) epoxy resin, (N) phenolic resin and (O) urea resin and at least two organic pigments selected from the group consisting of (a) condensed azo type yellow pigment, (b) isoindolinone type yellow pigment, (c) isoindolinone type orange pigment, (d) diketopyrrolopyrrole type orange pigment, (e) diketopyrrolopyrrole type red pigment, (f) condensed azo type red pigment, (g) anthraquinone type red pigment, (h) quinacridone type red pigment, (i) quinacridone type violet pigment, (j) anthraquinone type blue pigment, (k) phthalocyanine type blue pigment and (l) phthalocyanine type green pigment, wherein said organic pigments are incorporated into the composition in an amount of 0.01 to 2% by weight based on the total plastic composition according to the addition-mixing method so as to form a black, brown, gray, violet, blue or green color.

3. A solar heat-reflecting plastic composition according to claim 2, wherein the resin is selected from the group consisting of (A) vinyl chloride resin, (B) polypropylene, (C) polyethylene and (G) polyurethane.

4. A solar heat-reflecting plastic composition according to claim 2, wherein the resin is (A) vinyl chloride resin.

5. A method of imparting pigments to a resin said method comprising the steps of
a) mixing at least two organic pigments selected from the group as described in claim 2 into a reaction mixture comprising a resin selected from the group as described in claim 2 using the dry kneading method, the pigment being added in an amount within the range from 0,01 to 2% by weight, the amounts of each pigment being proportioned to produce a desired color,
b) heating the mixture to a temperature at least equal to a melting temperature of the resin to prepare a sheet.

6. (canceled)

7. A method of imparting pigments to a resin said method comprising the steps of
a) mixing at least two organic pigments selected from the group as described in claim 3 into a reaction mixture comprising a resin selected from the group as described in claim 3 using the dry kneading method, the pigment being added in an amount within the range from 0,01 to 2% by weight, the amounts of each pigment being proportioned to produce a desired color,
b) heating the mixture to a temperature at least equal to a melting temperature of the resin to prepare a sheet.

8. A method of imparting pigments to a resin said method comprising the steps of
a) mixing at least two organic pigments selected from the group as described in claim 4 into a reaction mixture comprising a resin selected from the group as described in claim 4 using the dry kneading method, the pigment being added in an amount within the range from 0,01 to 2% by weight, the amounts of each pigment being proportioned to produce a desired color,
b) heating the mixture to a temperature at least equal to a melting temperature of the resin to prepare a sheet.
